(19) United States
(12) Patent Application Publication
(10) Pub. No.: US 2011/0089677 A1
(43) Pub. Date: Apr. 21, 2011

(54) SECURITY SHEET INCLUDING A RIBBON PRESENTING A ZONE OF REDUCED OPACITY

(75) Inventor: Henri Rosset, Le Pin (FR)

(73) Assignee: ARJOWIGGINS SECURITY, Issy Les Moulineaux (FR)

(21) Appl. No.: 12/936,549

(22) PCT Filed: Apr. 7, 2009
(86) PCT No.: PCT/FR09/50595

§ 371 Date: Nov. 23, 2010

(30) Foreign Application Priority Data
Apr. 11, 2008 (FR) 0852469

(51) Int. Cl. B42D 15/00

(52) U.S. Cl. 283/85

(57) ABSTRACT

A sheet comprising a fiber substrate and at least one ribbon defining at least one zone of reduced opacity, the sheet including at least two complementary security elements situated respectively on either side of said at least one ribbon and of complementarity that is observable in show-through by virtue of the zone of reduced opacity.

The present invention relates to the field of security documents, and more particularly to the field of security sheets. The invention relates to a security sheet, e.g. made for the most part out of paper, and including a security ribbon presenting a zone of reduced opacity that enables particular security effects to be created that can be observed in show-through.

In the description, the term “paper” means any sheet obtained by a wet method from a suspension fibers of natural cellulose and/or vegetable, mineral, or organic fibers other than cellulose fibers, possibly synthetic fibers, and possibly containing a variety of fillers and a variety of additives as commonly used in papermaking.

### BACKGROUND

In the field of security sheets, it is sometimes desirable to obtain a localized zone of reduced opacity in a sheet in order to enable special effects to be created on the sheet, these effects being visible by show-through observation, for example. The particular effects that are produced may specifically be the result of complementary printing on the recto and the verso of the sheet, with the observation of the complementarity of the printing being facilitated in the zone of reduced opacity.

European patent application EP 1 122 360 describes a method of fabricating a security sheet that presents a zone of reduced opacity that is obtained by the presence of a screened watermark. That zone of reduced opacity enables various authentication patterns to be created on the sheet from printing on the recto and the verso of the sheet.

Nevertheless, the solutions proposed in the prior art present several drawbacks. For example, they generally require a considerable reduction in the content of fibers in the sheet in the zone of reduced opacity, thereby giving rise to significant mechanical weakness in said zone. As a result, any security elements, e.g. printing, may be difficult to place in the zone of reduced opacity and often they need to appear in zones that are subjected to smaller amounts of stress. In particular, creating a zone of reduced opacity in the prior art frequently gives rise to a reduction in the thickness of the security sheet in that zone, where said reduction in thickness is difficult to control and often too great, and as a result the sheet is easily struck through, e.g. by ink passing through the sheet during a printing step.

### SUMMARY

Consequently, there exists a need to remedy at least some of the above-mentioned drawbacks.

In particular, there exists a need to improve the fabrication of security documents, in particular security sheets, in particular for making zones of reduced opacity in documents that enable particular effects to be obtained in said zones.

The invention seeks to satisfy those needs in full or in part, in particular by incorporating a ribbon presenting a zone of reduced opacity in the security sheet.

In one of its aspects, the invention thus provides a sheet comprising a fiber substrate and at least one ribbon defining at least one zone of reduced opacity, the sheet including at least two complementary security elements situated respectively on either side of said at least one ribbon and of complementarity that is observable in show-through by virtue of the zone of reduced opacity.

By way of example, the security elements are situated respectively on the recto and the verso of the substrate. In a variant, one of the security elements is situated on the ribbon and the other on the substrate. One of the security elements may for example be on the recto of the substrate and the other security element on the verso of the ribbon, or vice versa, thereby enabling visual pollution in reflection to be reduced.

The security elements may also be situated respectively on the recto and the verso of the ribbon.

It is also possible to have at least two complementary security elements situated respectively on the recto and the verso of the substrate, of complementarity that is observable in show-through in the zone of reduced opacity of the ribbon, and the ribbon may include on at least one of its faces at least one additional security element that is complementary to at least one of the complementary security elements of the sheet.

All of the complementary security elements may overlie the ribbon in full or in part when the sheet is observed in face view. In a variant, at least one of the complementary security elements does not overlie the ribbon, e.g. being present on the verso or the recto of the fiber substrate. For example, the substrate may receive on the recto and/or the verso faces a security element in the form of printing that, when the sheet is observed in show-through, co-operates with another security element that is made visible by the zone of reduced opacity, so as to form a particular pattern, e.g. a word, a number, a design, or a logo.

Thus, the security element of the substrate and the security element(s) of the ribbon make it possible, by virtue of their complementarity, to observe in show-through a particular pattern, design, etc. . . . . This complementarity may be observed in the zone of reduced opacity of the ribbon. The term “complementarity” covers any type of optical interaction between the security elements.

The term “reduced opacity” is used to mean that the opacity of the zone of reduced opacity is less than the opacity of the substrate, or indeed less than the opacity of the remainder of the ribbon, when the zone of reduced opacity occupies only a fraction of the ribbon.

The zone of reduced opacity preferably extends over the entire ribbon. As a result, the entire ribbon presents opacity that is less than that of the substrate. Thus, the term “zone of reduced opacity” may designate equally well a restricted zone of the ribbon of dimensions that are smaller than the dimensions of the ribbon, or the ribbon itself when the zone of reduced opacity occupies the entire ribbon.

The term “complementary security elements” is used to mean security elements that, when observed in show-through, cause a particular effect to be observed, e.g. a pattern that is produced by superposition of the security elements, resulting from the complementarity between the security elements. The pattern may be an alphanumeric character or a design or a logo, e.g. one that is present elsewhere on the document.

The term “observable in show-through” is used to mean that light that is observed has passed through the ribbon in the thickness direction, e.g. visible, ultraviolet, or infrared light.

By means of the invention, it is possible to obtain a security sheet that presents a zone of reduced opacity, while remedying at least some of the drawbacks of the prior art. Since the zone of reduced opacity is carried by a ribbon that is incorporated in the substrate of the security sheet, the invention makes it possible to avoid problems of mechanical weakness that result from making the zone of reduced opacity directly in the substrate of the security sheet. Furthermore, the presence of a ribbon defining a zone of reduced opacity within the security sheet may advantageously serve to avoid the presence of reduced thickness in the zone of reduced opacity, and as a result may serve to reduce any risk of striking through the sheet.

### Ribbon

The term “ribbon” is used to designate a ribbon made as a single piece or as an assembly, a stack, or a juxtaposition of individual pieces or strips.

The ribbon may define one or more zones of reduced opacity. In a variant, the zone of reduced opacity may cover the entire ribbon, in which case the ribbon presents opacity that is less than that of the substrate. Under such circumstances, it is possible to obtain a security sheet including a zone of reduced opacity that corresponds exactly to the dimensions of the ribbon.

When the ribbon includes a zone of reduced opacity that does not cover the entire ribbon, said zone may be made during a prior step of treating the ribbon before it is incorporated in the fiber substrate.

The ribbon may be incorporated totally in the fiber substrate, e.g. by being inserted into the material thereof or between two plies. Under such circumstances, the substrate may advantageously present opacity suitable for enabling the ribbon to be observed, and in particular for enabling the zone of reduced opacity of the ribbon to be observed in show-through.

By way of example, the ribbon may have its main faces completely covered by the substrate, in particular by the fibers of the substrate. In a variant, the ribbon may have at least one of its main faces covered by at least one element that is fitted onto the substrate.

The ribbon may be covered by thicknesses of fibers of the fiber substrate that are substantially equal on both faces of the ribbon. In a variant, the ribbon may be covered by fibers of the fiber substrate at a thickness that is smaller on one of the faces of the ribbon and greater on the other face of the ribbon.

The ribbon may be situated entirely at the surface of the security sheet, appearing on both faces of the security sheet. In a variant, the ribbon may be close to the surface of the security sheet via only one of its recto or the verso faces, the other face being entirely covered by the substrate.

The ribbon may also come flush to the surface of the security sheet either in one of its faces or in both of its faces, or it may be set back from or project from the surface of the security sheet.

The ribbon may be introduced into the material of the substrate in a single ply on a flat bed (Fourdrinier) or vat former papermaking machine. With a vat former the ribbon may for example be introduced into the forming vat before or shortly after the beginning of de-watering the fiber suspension on the fabric. The position of the ribbon in the thickness of the final security sheet is determined in particular by the position at which the ribbon is introduced and by its angle of inclination. The ply as obtained in this way may then be married while wet, i.e. before drying, with other plies of fiber compositions that may be identical or different and that may be formed on flat bed (Fourdrinier) or vat former papermaking machines.

In the zone of reduced opacity, the sheet may present substantially the same thickness as in the vellum zone of the sheet. The ribbon may be completely covered by the substrate on both of its main faces in the zone of reduced opacity.

The zone of reduced opacity may have various dimensions and shapes. For example, the zone of reduced opacity may be round, square, rectangular, oval, polygonal, or star-shaped, or more generally it may have outlines that are rectilinear and/or curvilinear, among others.

The zone of reduced opacity may present edges of irregular shape, e.g. in the form of broken or undulating lines, crenellations, zigzags, among others. The edges of the zone of reduced opacity may have the same shapes or they may have shapes that are different, being regular or irregular.

The zone of reduced opacity may be observed, e.g.

with the naked eye, by reflection or by transmission using visible, ultraviolet, or infrared light.

The zone of reduced opacity may present an opacity index that is less than or equal to 80%, preferably less than 50%, in accordance with the ISO 2469 standard.

The zone of reduced opacity, and thus optionally the entire ribbon, may be made from any material, or from a combination of a plurality of different materials. In particular, the ribbon may be a fiber ribbon and/or a plastics ribbon.

The zone of reduced opacity may be made from a mass of fiber, in particular of paper. The zone of reduced opacity may be made from a highly refined and non-filled fiber composition that presents low opacity. The zone of reduced opacity may be made from refined fibers having a Schöpper degree that is high, in particular greater than 65.

The zone of reduced opacity may be made from a tracing paper. In particular, the zone of reduced opacity may appear on a ribbon made of a tracing paper or indeed made of a tracing paper placed on the ribbon, e.g. by adhesive.

In the meaning of the present invention, and traditionally in the papermaking industry, the term “tracing paper” is used to mean a so-called “natural” tracing paper obtained from an aqueous composition of papermaking pulp containing fibers that have been highly refined.

Papermaking pulps need to be subjected to a refining step in order to hydrate and fibrillate the fibers. This step densifies the fiber mat that forms on the fabric of the papermaking machine and enables the physical and optical characteristics of the sheet of paper to be controlled. When fabricating tracing paper, this refining step is applied thoroughly so as to obtain a sheet that is very dense with practically no air (voids), thereby imparting transparency to the paper.

In a variant, the zone of reduced opacity may be made from a composition of synthetic fibers, of the polyamide or polyester type, preferably without filler and thus presenting little opacity. The zone of reduced opacity may also be made from a composition of polyolefin fibers, e.g. of polyethylene, these fibers being subjected to melting by applying heat treatment to the sheet, in particular hot embossing performed on the security sheet after it has been formed.

In another variant, the zone of reduced opacity may be made from a polymer material, in particular a thermoplastic material, e.g. a plastics ribbon that is transparent or opalescent, or slightly opalescent, e.g. made of polyolefin, in particular polyethylene, or polyester.

When said polymer material is opaque or translucent, e.g. for a porous plastics material, its opacity may be reduced, in particular by hot embossing.

The zone of reduced opacity may be fabricated from a material, in particular a tracing paper, that has previously been subjected to wet strength (WS) treatment.

The ribbon may present wet strength (WS) in traction that is greater than 30%, in particular so as to avoid problems when inserting the ribbon in the sheet. Wet strength in traction is measured by dividing the wet strength value in traction as measured using the standard NF Q 03.056 by the dry strength value in traction as measured using the standard NF EN ISO 1924. This wet strength may be provided in particular in conventional manner by adding a wet strength agent, e.g. such as a polyamine amide epichlorhydrine (PAAE) resin, a melamine formol resin, etc. . . . .

In a variant, additional wet strength (WS) may be obtained by adding a fraction of the WS agent(s) in fibrous sheet surface treatment baths, e.g. used in fabricating the ribbon.

The ribbon may be made from a crease-resistant fiber sheet that is transparent or translucent, having an opacity index of less than 50% and comprising fibers, an anionic polymer presenting a glass transition temperature higher than −45° C. and at a concentration lying in the range 5% to 40% by dry weight relative to the total dry weight of the sheet, and a main cationic flocculation agent at a concentration lying in the range 0.1% to 10% by dry weight relative to the total dry weight of the sheet.

The substrate may include one or more security elements on its recto face and one or more security elements on its verso face, the recto face security elements being complementary to the verso face security elements.

When the fiber substrate includes at least one security element situated on the recto or the verso of the sheet, the ribbon may include at least one zone of reduced opacity and at least one complementary security element situated on the recto or the verso of the ribbon, substantially in register with the security element situated on the recto or the verso of the sheet so as to obtain complementarity between the security element situated on the recto or the verso of the sheet and the security element situated on the recto or the verso of the ribbon, the complementarity being observable in show-through via the zone of reduced opacity.

It is also possible to have one security element on the recto of the substrate and the other security element on the verso of the ribbon, or vice versa.

When the substrate has at least two complementary security elements situated respectively on the recto and the verso of the substrate, and of complementarity that is observable in show-through via the zone of reduced opacity of the ribbon, the ribbon may include an additional security element on at least one of its faces, which additional security element serves, by (total or partial) complementarity with the complementary security elements of the substrate, to create a particular pattern by observation in show-through via the zone of reduced opacity of the ribbon.

The ribbon may include one or more security elements, these elements optionally corresponding to the above-mentioned complementary security elements or being additional security elements.

The ribbon may include at least one additional security element on one of its faces, or on both of its faces. The ribbon may include different additional security elements on each face.

The security elements may preferably be applied, e.g. by printing, in register on the zone of reduced opacity and/or the substrate. The term “printing in register” is used to mean that the security elements are in determined positions relative to the zone of reduced opacity.

### Complementarity

On their own, the security elements may represent various patterns in complete or partial manner, e.g. one or more alphanumeric characters or designs or logos, e.g. as present elsewhere on the document.

The complementarity of the security elements as observed in show-through may cause other patterns to appear, e.g. one or more alphanumeric characters or designs or logos, e.g. present elsewhere on the document.

The complementary security elements may enable at least one pattern to be observed in show-through which pattern has a particular meaning for a user.

The security elements may form patterns that are juxtaposed when observed in show-through, or in a variant the patterns may be superposed in full or in part.

The complementary security elements may present a small amount of opacity, in particular opacity that is different from the opacity of the zone of reduced opacity and/or from the remainder of the ribbon, and in particular greater opacity. The opacity may be sufficient to cause contrast to appear between the security elements and the zone of reduced opacity and/or the ribbon when observed in show-through.

The security elements may be printing. The inks used may include other additional security elements, such as specific pigments, for example.

The security elements may include an electronic device, e.g. a chip. For example, a security element may be a chip constituting the dot on a letter “i” that is otherwise formed by other security elements such as printing, for example.

The security elements may enable various, optionally variable, optical effects to be obtained as a result of their complementarity when observed in show-through.

The security elements may for example enable a “moiré” effect to be obtained in show-through.

By way of example, a moiré effect may reveal a pattern that is produced by superposing two security elements, e.g. by lines of the two security elements coming close together. For example, a first print may be made on the recto face of the substrate and a second print may be made on the verso face of the substrate. When observed in show-through via the zone of reduced opacity, a complementary pattern may appear by moiré effect between the first and second prints.

The security elements may also serve to obtain “combinatorial” effects in show-through, for example.

A “combinatorial” effect results from observing a particular pattern in show-through that is the result of combining two patterns each appearing on respective sides of the ribbon, e.g. on the recto and the verso of the substrate. For example, a first pattern may be printed on the recto of the substrate and a second pattern may be printed on the verso of the substrate. When observed in show-through, a third pattern can then be seen as a result of combining the first and second patterns.

Advantageously, the zone of reduced opacity may present sufficient transparency to enable a combinatorial effect to be observed.

Moiré effects and combinatorial effects may be achieved other than by printing on the recto and verso faces of the ribbon.

For example, a foil, i.e. a partially metal-plated or printed thin film may be transferred while hot and/or a patch may be applied to the recto face and/or to the verso face of the fiber substrate. Under such circumstances, the security elements may appear on such a foil or patch. By way of example, the foil or patch may be printed, metal-plated, or have metal stripped therefrom.

The complementarity between the foils and/or the patches appearing on either side of the ribbon, e.g. on the recto and verso faces of the fiber substrate, may make it possible to obtain the same moiré and/or combinatorial effects as described above. For example the complementarity may occur between printing carried by the foils and/or patches. Complementarity may also occur between metal-plated patterns carried by the foils and/or patches.

The ribbon may include at least one security element placed directly on the ribbon, e.g. by printing, said element being complementary to at least one pattern of a foil and/or a patch appearing on the recto and/or the verso face of the substrate.

The ribbon may also be printed with one or more transparentizing inks, in particular in the zone of reduced opacity. The transparentizing ink(s) may be associated with at least one security element situated on one side of the ribbon, e.g. a plurality of security elements situated on the recto and/or the verso of the ribbon.

Advantageously, the use of transparentizing inks may enable the color of the ribbon to be conserved. Thus, the zone on which a transparentizing ink has been applied, in particular the zone of reduced opacity, may have the same color as the zones of the ribbon where no transparentizing ink has been applied. As a result, the transparentizing ink(s) need not generate a difference in color between the zone(s) where they appear and the zone(s) of the ribbon that do not include any transparentizing ink.

A ribbon without color and without filler may be introduced in the colored fiber substrate. As a result, it is possible to obtain a color difference between the ribbon and the substrate. Optionally, one or more transparentizing inks may be applied to the ribbon.

One or more transparentizing inks may be applied to a zone of the ribbon of opacity that has been reduced by other means, thereby creating one or more zones of increased transparency in the ribbon.

When the ribbon includes zones where one or more transparentizing inks have been applied, but not only under such circumstances, it is possible to apply other security elements, preferably visible elements, to the ribbon in said zones and away from said zones.

It is possible to print one or more patterns on the ribbon with one or more transparentizing inks, in particular in the zone of reduced opacity, said pattern(s) defining one or more show-through observation windows of the security sheet. By way of example, such patterns may enable a user to better identify on the security sheet the location where the zone of reduced opacity appears and thus the location that may be observed in show-through. The printing of these patterns may enable a printer to create all kinds of designs, e.g. a logo or some particular symbol. The printing of one or more patterns corresponding to one or more observation windows may be associated with one or more security elements on either side of the ribbon.

The observation window(s) may be of varying shapes and sizes. The observation window(s) may for example be round, square, rectangular, oval, polygonal, or star-shaped, or more generally may have outlines that are rectilinear and/or curvilinear, among others. They may also for example present edges of irregular shape, e.g. in the form of broken or undulating lines, crenellations, zigzags, among others. The edges may have the same shapes or they may have different shapes, which shapes may be regular or irregular.

The transparentizing ink(s) may be applied to both the recto and the verso faces of the ribbon, or indeed to only one face of the ribbon. When only one of the recto and the verso faces of the ribbon includes one or more transparentizing inks, the inks may advantageously be observable from the other face of the ribbon, in particular as a result of the opacity of the ribbon in the zone of reduced opacity.

In an embodiment of the invention in which the security sheet including the ribbon has at least one zone of reduced opacity, the sheet may include printing, e.g. iridescent printing, applied to the substrate and overlying the ribbon with the exception of a reserved zone without printing, thereby forming an observation window in said zone of reduced opacity.

When the ribbon includes zones where one or more transparentizing inks have been applied to the zone of reduced opacity, and printing, e.g. iridescent printing, is applied to said zone of reduced opacity of the ribbon with the exception of said zones where one or more transparentizing inks have been applied, the ribbon then presents non-printed reserved zones forming observation windows of increased transparency in the zone of reduced opacity of the ribbon.

The ribbon may be a fiber ribbon, e.g. being based on cellulose fibers (in particular cotton fibers) and/or natural organic fibers other than cellulose fibers, and/or synthetic fibers, e.g. such as polyester or polyamide fibers, and/or optionally mineral fibers, e.g. such as glass fibers. The ribbon need not include fibers of polyvinyl alcohol (PVA).

The fibers may be hydrophilic, in particular so as to develop chemical bonds, mainly hydrogen bonds, with the fiber substrate.

The ribbon may have at least 50% cellulose fibers in weight.

The ribbon may present a weight lying in the range 5 grams per square meter (g/m²) to 100 g/m², preferably lying in the range 15 g/m² to 55 g/m², and more preferably in the range 20 g/m² to 30 g/m².

The ribbon may have a width lying in the range 2 millimeters (mm) to 60 mm, preferably in the range 4 mm to 30 mm, and more preferably in the range 10 mm to 20 mm.

The ribbon may have thickness lying in the range 20 micrometers (μm) to 120 μm, preferably in the range 30 μm to 80 μm, and more preferably in the range 45 μm to 55 μm.

The ribbon may optionally be combined with a strip of thermoplastic and/or metallic material, e.g. polyethylene terephthalate (PET), pasted or hot-laminated to the ribbon before it is introduced into the fiber substrate.

Incorporating the ribbon in the substrate need not give rise to extra thickness of the security sheet. For example, the ribbon may be introduced into the fiber substrate using the method described in application EP 0 773 320.

The ribbon need not have a watermark.

The substrate may optionally include a watermark. When the substrate includes a watermark, at least part of the watermark may overlie the zone of reduced opacity.

The ribbon may present optical properties that are different from those of the fiber substrate, in particular properties concerning color, fluorescence, phosphorescence, magneto-optics, photochromy, thermochromy, piezochromy, or other properties.

For example, the substrate and the ribbon may have different colors. Any color is possible. The ribbon and the substrate may present a color or colorimetric difference ΔE (using the CIE Lab 1976 color space) that is greater than 0.2 and preferably greater than 1. Nevertheless, the human eye is more sensitive to a color difference on hues that are not saturated, and the person skilled in the art may adapt the color difference so as to obtain the desired level of “contrast”.

The substrate and/or the ribbon may also include, e.g. in addition to any transparentizing ink, a conventional or security ink, in particular an ink that is fluorescent, phosphorescent, magnetic, photochromic, thermochromic, piezochromic, among others. This ink may constitute a security element of the recto and/or the verso faces of the ribbon. The ink may be applied in part or completely to the ribbon, i.e. on certain zones only of the surface of the ribbon, in particular on the zone of reduced opacity, or over the entire surface of the ribbon. The ink may be applied to the ribbon and/or the substrate by printer means, such as for example offset, photogravure, silkscreen, or ink-jet printer means.

The complementary security elements may be made using one of the above-mentioned inks.

The ribbon and/or the substrate may also be coated in a varnish that is transparent or colored.

The ribbon and/or the substrate may include a fluorescent agent. The fluorescent agent may optionally be colored, and may be visible or invisible in visible light. By way of example the fluorescent agent may be incorporated in the material of the ribbon. By way of example the fluorescent agent may be visible under ultraviolet (UV) light and/or infrared (IR) light.

Preferably, the ribbon may extend between two opposite edges of the sheet.

The ribbon may present edges of irregular shape, e.g. in the form of broken or undulating, crenellated, zigzag, or other lines. The edges of the ribbon may be of shapes that are the same or different, that are regular or irregular.

The ribbon may also present characteristics that are perceptible, e.g. on sight, or to the touch.

By way of example, the ribbon may be embossed, thereby serving to create a particular effect, e.g. a touch effect or a surface relief effect, the ribbon being able to appear in part on the surface of the fiber substrate.

The ribbon may be coated in a thermoplastic polymer and then optionally embossed after it has been coated.

The ribbon may be printed with drops of varnish, of resin, or of hot-puff ink, among others.

In part and in certain zones the ribbon may include a hot-puff ink serving to create at least one portion in relief, the ink being activated prior to introducing the ribbon into the fiber substrate. Activation prior to incorporation serves to reduce the risk of the sheet being destroyed as the ink swells.

The ribbon may include particles, e.g. detectable to the naked eye or to the touch, that are introduced into the material of the ribbon, e.g. in the form of beads, e.g. beads of synthetic material, e.g. polyurethane, or of inorganic material, e.g. glass, the beads presenting a size of less than 300 μm, for example, or being provided by silkscreen or photogravure deposition, e.g. in the form of beads, e.g. presenting a size of less than 100 μm.

The ribbon may include a textile strip, e.g. a knitted strip, that is incorporated in the ribbon or is pasted thereto.

The ribbon may include, in part and in localized manner, printing in relief, e.g. silkscreen printing.

The ribbon may present a rough, smooth, silky, smooth, or other feel.

The ribbon may advantageously conserve its own cohesion after being introduced into the fiber substrate. After it has been introduced into the fiber substrate, the structure of the ribbon may be observable under certain conditions, e.g. in section or by viewing in reflection or in transmission. Thus, it is possible to observe the ribbon by differences in optical properties, e.g. differences in contrast, hue, saturation, paleness, or opaqueness, that make the frontier between the ribbon and the substrate visible or that characterize the presence of the ribbon.

The ribbon may also be observable topographically in the sheet.

The ribbon may also be observable in transparency through the sheet, in particular to the naked eye.

The ribbon may include perforations, in particular in order to facilitate de-watering while fabricating the sheet or indeed to add an additional optical effect. For example, these perforations may be disposed at the margin of the ribbon or in such a manner as to form a pattern or a code.

Among the security elements, some are detectable to the naked eye in visible light without using any particular appliance. Advantageously, the zone of reduced opacity of the ribbon of the security sheet of the invention serves to increase the visibility of certain security elements. By way of example, these security elements comprise colored fibers or flakes, and threads that are printed or metal-plated in full or in part.

Such security elements are said to be “first-level” elements.

Other types of security element may be detected solely with the help of an appliance that is relatively simple such as a lamp emitting ultraviolet or infrared light. By way of example such security elements include fibers, flakes, strips, threads, or particles. These security elements may optionally be visible to the naked eye, e.g. luminescing when illuminated with a Wood lamp emitting at a wavelength of 365 nanometers (nm).

These security elements are said to be “second level” elements.

Still further types of security elements require a more sophisticated detector appliance in order to be detected. By way of example, these security elements are capable of generating a specific signal on being subjected simultaneously or otherwise to one or more external excitation sources. Automatic detection of the signal enables a document to be authenticated, where appropriate.

By way of example, these security elements include tracers that are present in the form of active material, particles, or fibers capable of generating a specific signal when the tracers are subjected to optronic, electric, magnetic, or electromagnetic excitation.

These security elements are said to be “third level” elements.

The security elements present on the ribbon and/or the substrate, particularly in the zone of reduced opacity, may present first, second, or third level security characteristics.

The security elements may in particular be selected from tracers, in particular nanometric tracers, security fibers, in particular fibers that are metallic, magnetic (with soft and/or hard magnetism), or absorbent or excitable in the ultraviolet (UV), the visible or the infrared (IR), and in particular in the near infrared (NIR), security elements that are flat and of relatively small format such as flakes, pigments or agglomerations of pigments in particular those that are absorbent or excitable under laser illumination or illumination in the ultraviolet (UV), visible, or infrared (IR), and in particular in the near infrared (NIR), and security threads (based on plastics, in particular polyester) including in particular an at least partial coating, being metallic, metal-plated, iridescent, or magnetic (with soft and/or hard magnetism), the coating potentially including positive or negative patterns, and said patterns being obtainable in particular by removing metal, and combinations thereof.

The incorporation of tracers in a security sheet by means of the ribbon is localized, thus making it possible in particular to create a zone, possibly invisible to the naked eye, for recognizing and/or authenticating said security document. The recognition and/or authentication of said document may be based in particular on the intensity and/or the type of signal generated by the tracers, whether considered individually or otherwise, on the density of the tracers, or indeed on their spatial distribution in an optionally predefined zone of the document. In particular, randomly-distributed tracers may form a signature that is unique and may thus be used for identification purposes.

In particular, the introduction into the security sheet of pigments or agglomerations of pigments that absorb in the infrared or in the near infrared, as mentioned above, may be used to make said sheet authentifiable, as described in patent application WO 2005/034049.

In the particular circumstance of a ribbon that includes magnetic fibers, authentication may be performed by analyzing the magnetic response signal. In particular, seeding fibers with so-called “soft” magnetism in the fiber suspension prior to de-watering it, i.e. introducing them into the mixture of the fiber suspension, makes it possible reproducibly to obtain a uniform distribution of soft magnetic fibers. However, introducing soft magnetic fibers in a strip in accordance with the prior art, i.e. in a vat former via localized feed pipes or by laminar streams over a flat bed, gives rise to a certain amount of variability in the concentration of the soft magnetic fibers, and also in the width of the strip of soft magnetic fibers. By using a security ribbon fabricated by being cut out from a sheet including soft magnetic fibers that were seeded therein, the invention makes it possible to obtain in reproducible manner a uniform distribution of soft magnetic fibers. Thus, by varying the concentration of soft magnetic fibers and by varying the width of the security ribbon that is introduced, it is possible to increase the number of potentially available magnetic signals or “signatures”.

In a particular embodiment of the invention, the ribbon includes in the range 0.1% to 1% by dry weight of magnetic fibers, in particular soft magnetic fibers, relative to the total quantity of fibers, and preferably in the range 0.2% to 0.6%.

The ribbon may include a plurality of flakes distributed with a density per unit area lying in the range 4000 flakes per square meter (flakes/m²) to 25,000 flakes/m², preferably in the range 5000 flakes/m² to 20,000 flakes/m², and more preferably in the range 11,000 flakes/m² to 18,000 flakes/m². Because of the zone of reduced opacity of the ribbon, the flakes can be made more visible in show-through.

The ribbon may have a series of parallel security threads, and more particularly the succession of inter-thread spaces and/or the series of substrate threads of different widths may constitute a code, in particular of the bar code type.

The ribbon may include a soft magnetic anti-theft wire. This type of anti-theft security wire may be very sharp and thus difficult to incorporate in a security sheet. In particular, it can happen that the anti-theft wire, while being introduced in the prior art, i.e directly in a fiber substrate, is not completely covered by the fibers. Incorporating such an anti-theft security wire in the present invention consists in fabricating a fiber sheet having one or more anti-theft security wires introduced therein, with the resulting security sheet then being cut into ribbons each including at least one anti-theft wire. These ribbons are subsequently introduced into the fiber substrate. Thus, any zones of the ribbon that present gaps in fiber covering are themselves covered by the fiber material of the fiber substrate, so a security sheet is thus obtained that includes at least one anti-theft security wire and that does not have any gaps in its covering.

In a particular embodiment of the invention, the ribbon includes at least one electronic device. Preferably, the electronic device is a radiofrequency identification (RFI) device, in particular an electronic chip and/or an antenna that may in particular be printed on the ribbon. The zone of reduced opacity of the ribbon may enable the electronic device to be more visible within the security sheet.

The ribbon may include perforations in a pattern or a code. As a function of differences in opacity and in color between the substrate and the ribbon, the pattern or code is observable or is observable only in transmitted light or is observable both in transmitted light and in reflected light. If the ribbon possesses invisible fluorescent printing, the pattern may also be visible solely under UV illumination.

In particular, the pattern made by perforation includes at least one alphanumeric character or ideogram.

The ribbon may be calendared. Such calendaring is performed in particular in order to minimize the extra thickness created by introducing the ribbon.

The ribbon may include an adhesive, e.g. a heat-sealing agent, in order to improve its cohesion within the fiber substrate.

When the ribbon includes an adhesive, the adhesive may serve to enhance adhesion of the ribbon in the sheet.

By way of example, the adhesive may be a heat-sealing coating, e.g. a heat-sealing varnish, a UV-curable agent, an irradiation-sensitive adhesive, a pressure-sensitive adhesive (PSA), a solvent-based varnish, e.g. of the polyester type, an aqueous phase adhesive, etc. . . . .

As aqueous phase adhesive, mention may be made in particular of the following trademarks: Mowilith DC (an aqueous dispersion of vinyl acetate homopolymer with particles having a size lying in the range 0.3 μm to 2 μm and a glass transition temperature T_{g} of about 38° C., and a solid matter dry content lying in the range 55% to 57%), and Vinamul 3265 from the supplier Celanese; DH9004, DH9017, DH9044, and DL5001 from the supplier Collano; Primal NW1845, Primal LC40, Primal P308M, and Primal EP6000 from the supplier Rohm & Haas; 006SDW078-2 from the supplier BASF.

The adhesive may advantageously be an adhesive based on polyvinyl acetate, such as Mowilith DC.

The Applicant has observed that among the above-mentioned adhesives, Vinamul 3265, Mowilith DC, Collano DL5001, Primal NW1845, and Primal P308M present very good results in the dry crease test, i.e. the adhesion of the ribbon in the paper is not excessively affected by creasing.

Furthermore, Vinamul 3265 and Mowilith DC also present very good results in the wet crease test. Mowilith DC presents very good results in the washing test.

Also, Mowilith DC provides very good results in terms of adhesive power, but the invention is not limited to any particular adhesive.

In an embodiment of the invention the adhesive is not present in the form of fibers nor in the form of particles.

The adhesive may be added to the security ribbon in particular by a coating method, by a surface-application method, e.g. coating, or by methods derived from techniques for printing a paper base after it has been fabricated, e.g. air-knife coating, photogravure, silkscreen-printing, curtain coating, flexography, among others.

The adhesive may be applied, e.g. on a fiber sheet used for fabricating the ribbon, e.g. at a rate of 2 g/m² to 15 g/m² per face, preferably at a rate of 3 g/m² to 8 g/m² per face.

The sealing temperature may lie in the range 70° C. to 135° C., for example, depending on the adhesive used, and the sealing may take place while the security sheet is being dried.

The surface application may be performed on the surface, or at least in part to the core, i.e. it may penetrate deep, possibly over the entire ribbon.

Preferably, the surface application is performed on the medium that is used for fabricating the ribbon prior to cutting up said medium. In a variant, the surface application may be performed while fabricating the medium that is used for fabricating the ribbon.

The surface application may be performed on a single face of the medium or on both faces thereof. The adhesive may cover completely the face on which it is deposited.

The adhesive may also be incorporated in the ribbon by impregnation, by immersing the ribbon or the medium used for fabricating it in a bath.

In an embodiment of the invention, a 20 g/m² fiber sheet that has been subjected to wet strength (WS) treatment is coated with an aqueous phase adhesive at 5 g/m² per face, using a photogravure method, for example. This obtains a satisfactory compromise between adhesive power and the quantity of coated material.

In order to detect the presence of adhesive in a security sheet of the invention, it is possible to observe the adhesive, e.g. the heat-sealing varnish, in the form of bubbles, e.g. using a scanning electron microscope (SEM).

### Substrate

The term “substrate” designates a fiber sheet that may in particular comprise one or more fiber layers. In particular, the term “ply” is used to designate layers that are produced continuously on a given papermaking machine and then associated while in the wet state.

The substrate may include at least one security element, in particular selected from tracers, in particular nanometric tracers, security fibers, in particular fibers that are metallic, magnetic (with soft and/or hard magnetism), or absorbent or excitable in the ultraviolet (UV), the visible or the infrared (IR), and in particular in the near infrared (NIR), security elements that are flat and of relatively small format such as flakes, pigments or agglomerations of pigments in particular those that are absorbent or excitable under laser illumination or illumination in the ultraviolet (UV), visible, or infrared (IR), and in particular in the near infrared (NIR), and security threads (based on plastics, in particular polyester) including in particular an at least partial coating, being metallic, metal-plated, iridescent, or magnetic (with soft and/or hard magnetism), the coating potentially including positive or negative patterns, and said patterns being obtainable in particular by removing metal, chemical or biochemical reagents for countering falsification and/or authentication, in particular being suitable for reacting with at least one falsification and/or authentication and/or identification agent, respectively, and optically variable elements, in particular holograms, liquid crystals, iridescent pigments, or mirror effect structures, in particular dielectric structures, and combinations thereof.

The fiber substrate may in particular include security elements that are visible to the naked eye, but it may also include tracers that are in the form of active material, particles, or fibers, capable of generating a specific signal when the tracers are subjected to an optronic, electric, magnetic, or electromagnetic excitation. Such “tracers” constitute a substance that is identifiable by means of a distinctive property and that is used to mark an element (here a security document) and to enable it to be tracked, its evolution to be tracked, or enabling it to be recognized, authenticated, or identified.

Mirror dielectric structures are constituted by alternating layers of high and low refractive index, e.g. respective layers of hafnium dioxide and of silicon dioxide, and may in particular be obtained by ion etching.

In a particular embodiment of the invention, the fiber substrate includes at least one chemical or biochemical reagent for countering falsification and/or for authentication and/or for identification that reacts in colored manner with at least one agent respectively for falsification and/or authentication and/or identification.

The fiber substrate may be based on fibers such as those described above for the ribbon. The substrate further includes common additives, particularly mineral fillers imparting greater opacity than that of the ribbon.

In particular embodiment of the invention, the fiber substrate and the ribbon are based on the same fibers, i.e. their fiber composition is the same in terms of nature and preferably in terms of proportions, thus ensuring good affinity between the components and possibly also constituting additional authentication means.

### Sheet

Preferably, the sheet comprises at least two plies and is made in a papermaking machine on a vat former, the ribbon being introduced while one of the plies is being formed, e.g. in the wet portion of the machine.

It is also possible for incorporation to be performed using a single ply technique. In order to facilitate de-watering, one or more relatively narrow ribbons may be introduced, and when a plurality of ribbons are introduced they may be suitably spaced apart from one another.

It is also possible to use a ribbon that is microperforated at least in part so as to facilitate de-watering and its behavior in the sheet.

The sheet may also be formed on a papermaking machine that combines a flat bed (Fourdrinier machine) and a vat former.

The ribbon may also be introduced within the fiber substrate using prior art techniques for introducing security threads made of plastics material, or by pasting the ribbon between two sheets or fiber layers that then constitute the base of the fiber substrate.

### Security Document

The invention also provides a security document including a sheet as defined above.

The document may be fabricated by cutting, associating, binding, laminating, adhesively bonding, and/or pasting said sheet.

More particularly, the security document may constitute payment means, such as a bank note, a check, or a meal ticket, an identity document such as an identity card or a visa or a passport or a driver's license, a lottery ticket, a transport ticket, or indeed a ticket for entry to cultural or sporting events.

### Article to be Authenticated

The invention also provides an article to be authenticated that includes the sheet as defined or obtained above, the article being selected from a security label, packaging, in particular packaging for medication or for food or for cosmetics or for perfume or for electronic components or for spare parts, a sheet used in the medical or hospital field, in particular a sheet used for making sterilization packages, or indeed art paper

### Fabrication Method

The invention also provides a method of fabricating a sheet as defined above by a papermaking technique, wherein the ribbon is introduced into the fiber substrate in the wet portion. The combination of the substrate and the ribbon as obtained in this way is subsequently pressed and then dried.

In an implementation of the invention, the ribbon is inserted in the wet portion into the mass of the fiber substrate. For this purpose, it is possible to use methods known in the prior art for introducing security threads made of plastics material. The ribbon may present any of the characteristics set out above, or any combination thereof.

In another implementation of the invention, the method uses a papermaking machine that has at least one vat former, with the ribbon being introduced into the forming vat of the vat former before or shortly after the beginning of de-watering the composition that forms the fiber substrate of the sheet.

The method may also use a papermaking machine that is fitted with at least one flat bed (Fourdrinier machine), and the ribbon is introduced onto the flat bed while the composition forming the substrate of the sheet is de-watering.

The invention can be better understood on reading the following description of non-limiting embodiments of the invention and on examining the diagrammatic and fragmentary figures of the drawings, in which:

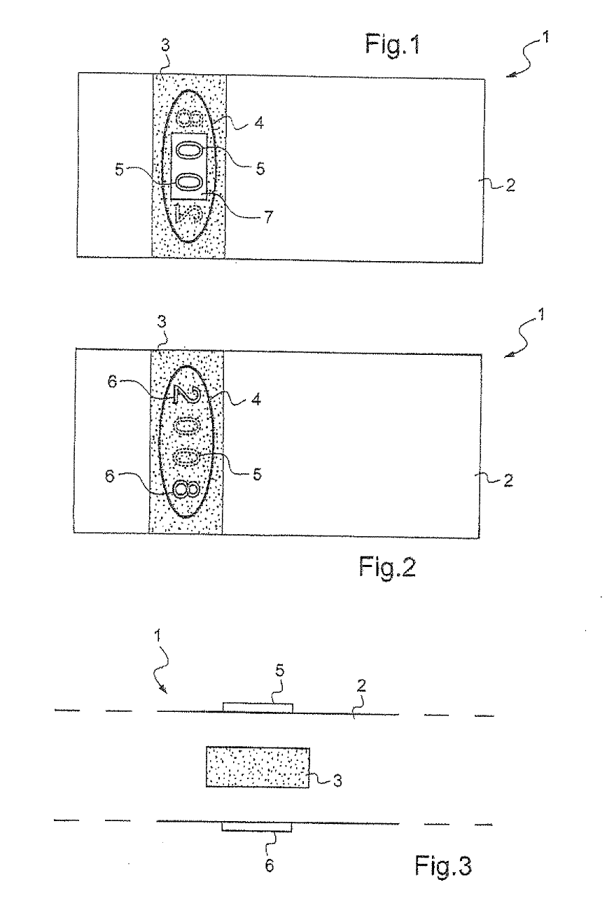

FIG. 1 is a face view showing the recto face of an example of a sheet of the invention;

FIG. 2 is a face view showing the verso face of the FIG. 1 sheet;

FIGS. 3 to 7 are section views showing examples of how security elements may be arranged in a sheet of the invention;

FIG. 8 is a face view of the recto face of another example sheet of the invention; and

FIG. 9 is a face view of the verso face of the FIG. 8 sheet.

FIG. 1 shows a sheet 1 in accordance with an embodiment of the invention, the sheet comprising a fiber substrate 2 and a ribbon 3.

In this example, although the ribbon 3 is visible in the drawing for better understanding, it is, in fact, incorporated completely within the fiber substrate 2. Preferably, the opacity of the substrate 2 is suitable for enabling the ribbon 3 to be seen. The ribbon 3 may optionally be incorporated in the fiber substrate 2 in such a manner as to be flush with the surface of the sheet 1 on one or both of its recto and verso faces.

The fiber ribbon 3 defines a zone 4 of reduced opacity. The zone 4 of reduced opacity may be obtained by the above-described method and may present one or more of the above-mentioned characteristics.

The recto face of the substrate 2, corresponding in this example to the recto face of the sheet 1, presents in the zone 4 of reduced opacity a security element 5 that is visible in reflection, e.g. in the form of two zero digits, as shown, which appear in this example on a transparent patch 7. All of the above-described variants for security elements are possible alternatives to the solution described in this example.

FIG. 2 shows the verso face of the FIG. 1 sheet 1. In this figure, it can be seen that the verso face of the substrate 2 (corresponding in this example to the verso face of the sheet 1) presents, in the zone 4 of reduced opacity of the ribbon 3, a second security element 6 in the form of the digits two and eight.

The security elements 5 and 6 respectively of the recto face and the verso face of the substrate 2 are complementary. They represent two distinct patterns.

When the zone 4 of reduced opacity of the ribbon 3 is observed in show-through, it is possible to observe a third pattern that results from superposing the patterns formed by the security elements 5 and 6, e.g. as a result of a moiré or combinatory effect, this third pattern corresponding in this example to 2008. By way of example, the two digits two and eight that show through are drawn in dashed lines in FIG. 2.

In the example of FIGS. 1 and 2, the security elements 5 and 6 are situated respectively on the recto and the verso of the substrate 2. In a variant, the security elements may be situated on at least one of the faces of the ribbon 3 and/or on at least one of the faces of the substrate 2. All of the above-described combinations are possible.

FIGS. 3 to 7 are section views showing a sheet 1 in accordance with the invention with various different possibilities for locating the security elements 5 and 6.

FIG. 3 shows a sheet 1 having security elements 5 and 6 situated respectively on the recto and the verso of the substrate 2.

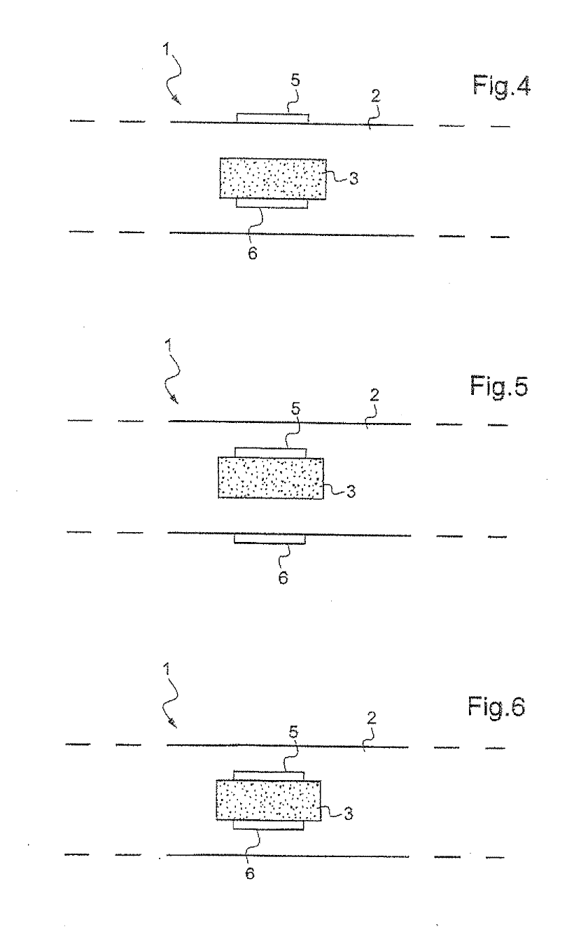

In the example of FIG. 4, the security element 5 is situated on the recto of the substrate 2 and the security element 6 is situated on the verso of the ribbon 3.

FIG. 5 shows a sheet 1 having a security element 5 situated on the recto of the ribbon 3 and a security element 6 situated on the verso of the substrate 2.

FIG. 6 shows a sheet 1 having two security elements 5 and 6 situated respectively on the recto and the verso of the ribbon 3.

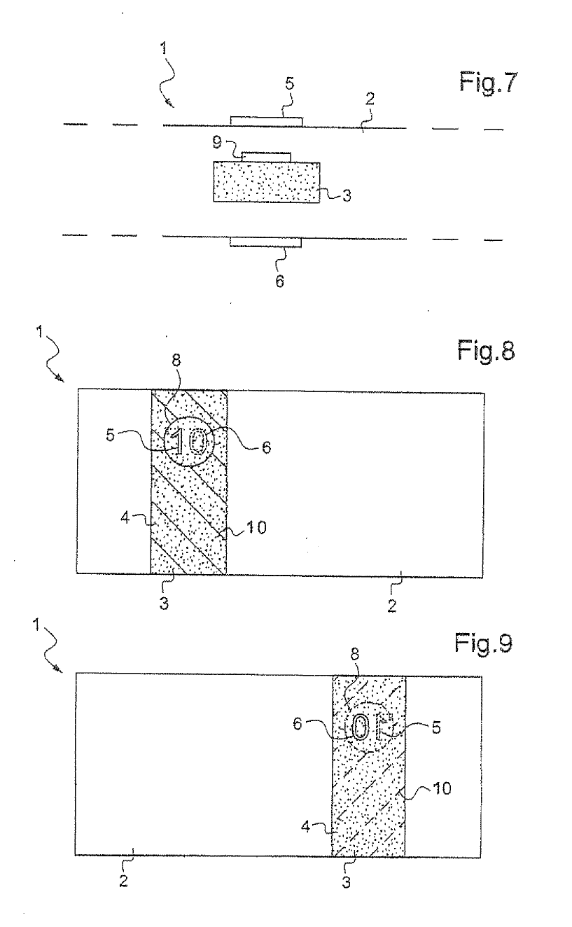

In the example of FIG. 7, the security elements 5 and 6 are situated respectively on the recto and the verso of the substrate 2. The sheet 1 also has another security element 9 situated on the recto of the ribbon 3. This security element 9 may be an additional security element such as those described above. The security element 9 may optionally be complementary to at least one of the security elements 5 and 6.

In the examples of FIGS. 1 to 7, the security elements 5 and 6, and optionally the security element 9, are complementary, with their complementarity being observable in show-through in the zone of reduced opacity, which zone may be located in a fraction of the ribbon 3 or may extend over the entire ribbon 3.

The dimensions of the security elements 5, 6, and 9 may be various, which elements may for example overlie one another in full or in part. The security elements 5, 6, and 9 may optionally be completely superposed on one another in the zone 4 of reduced opacity.

FIG. 8 shows the recto of another element of a sheet 1 of the invention.

The sheet 1 comprises a ribbon 3 and a fiber substrate 2. The zone 4 of reduced opacity corresponds to the entire ribbon 3 in this example, and it coincides therewith.

On its recto face, the substrate 2 carries an iridescent imprint 10 superposed on the zone 4 of reduced opacity of the ribbon 3 except for a reserved zone without printing that forms an observation window 8.

The security element 5, in the form of a digit in this example, is printed on the substrate 2 in the observation window 8, for example.

FIG. 9 shows the verso of the sheet 1 of FIG. 8.

In this figure, it can be seen that the opacity of the substrate 2 is sufficient for the observation window 8 and the zone 10 of iridescent printing to be seen in show-through.

A security element 6, in the form of the digit zero is printed, for example; on the verso of the substrate 2 in the observation window 8. The security elements 5 and 6 are complementary, observing the substrate 2 from the recto or the verso side of the sheet 1 in register with the ribbon 3 making it possible to observe the two digits one and zero, for example. The security elements 5 and 6 that can be seen in show-through are drawn in dashed lines in FIGS. 9 and 8.

The observation zone 8 may thus enable an observer to identify the zone on the sheet 1 where it is possible to observe the complementarity of the security elements 5 and 6.

Other security elements may be printed in the observation window 8 or may be printed in the zone 10 of iridescent printing. In a variant, the observation window 8 may itself constitute a security element.

### Ribbon Example 1

A paper ribbon was made from non-pigmented cotton fibers (i.e. with no filler), the ribbon also being subjected to a wet strength (WS) treatment by using polyamide amine epichlorhydrin resin. The ribbon then presented a weight of 37 g/m², a thickness of 51 μm and an opacity index of 69.4 measured using the ISO 2469 standard.

The ribbon presented a color defined by the following L*a*b* color coordinates: 94.8/0.53/1.60 (using the CIE Lab 1976 color space with illuminant D65 and an angle of observation of 10°).

The ribbon was introduced into a forming vat in a pigmented fiber suspension comprising cotton fibers, titanium dioxide, and coloring dyes, the ribbon also being treated so as to present wet strength (WS) and presenting a polyvinyl alcohol surface treatment.

That produced a security sheet having the following characteristics.

Where the ribbon was incorporated in the sheet, the total thickness of the sheet was 112 μm and its opacity index was 84.7. The measured color was defined by the following L*a*b* color coordinates: 94.8/0.14/4.83 under illuminant D65 and observation angle 10°.

In the vellum of the security sheet, the weight was 87.3 g/m², the thickness was 114 μm, and the opacity index was 90.1, giving a difference in opacity of 5.4 relative to the zone containing the ribbon. The measured color was then defined by the following L*a*b* color coordinates: 94.9/−0.28/5.24 under illuminant D65, angle of observation 10°.

### Ribbon Example 2

A tracing paper ribbon was fabricated by the wet method from a fiber suspension comprising highly refined softwood cellulose fibers, a carboxylated sytrene-butadiene copolymer, a flocculation agent in the form of a PAAE resin. The ribbon then presented a weight of 55.2 g/m², a thickness of 86 μm, and an opacity index of 40.3.

The ribbon presented a color defined by the following L*a*b* color coordinates: 84.1/−1.63 /0.92 under illuminant D65, observation angle 10°.

The ribbon was introduced into a forming vat in a pigmented fiber suspension comprising cotton fibers, titanium dioxide, and coloring dyes, and it was also given wet strength (WS) treatment and it presented polyvinyl alcohol surface treatment.

A security sheet was produced having the following characteristics.

At the ribbon incorporated in the sheet, the resulting thickness was 131 μm and the opacity index was 87.9. The measured color was defined by the following L*a*b* color coordinates: 90.1/2.21/5.91 under illuminant D65, observation angle 10°.

In the vellum zone of the security sheet, the weight was 92.5 g/m², the thickness was 108 μm, and the opacity index was 91.9, giving an opacity difference of 4 with the zone containing the ribbon. The measured color was then defined by the following L*a*b* color coordinates: 90.9/3.21/8.20 under illuminant D65, observation angle 10°.

The above two Examples 1 and 2 describe two ribbons suitable for use in the context of the present invention, the respective zones of reduced opacity of those two ribbons extending to each of the ribbons in full.

The complementary security elements appearing on the substrate may be as described above.

In particular, the substrates may include complementary security elements in the form of printing, the substrate then being printed on each of their faces. In Examples 1 and 2, the substrate could in particular include as security elements patterns in the form of two complementary digits printed respectively on each of the faces of the substrate, patterns of complementarity that can be observed in show-through in the zone of reduced opacity of the ribbon.

The expression “comprising a” is synonymous with “comprising at least one”, unless specified to the contrary.

1. A sheet comprising a fiber substrate and at least one ribbon defining at least one zone of reduced opacity, the sheet including at least two complementary security elements situated respectively on either side of said at least one ribbon and of complementarity that is observable in show-through by virtue of the zone of reduced opacity.

2. A sheet according to claim 1, the zone of reduced opacity covering the entire ribbon.

3. A sheet according to claim 1, the security elements being situated respectively on the recto and the verso of the substrate.

4. A sheet according to claim 1, one of the security elements being situated on the ribbon and the other on the substrate.

5. A sheet according to claim 4, the security elements being situated respectively on the recto of the substrate and on the verso of the ribbon, or vice versa.

6. A sheet according to claim 3, the ribbon including on at least one of its faces at least one additional security element that is complementary to at least one of the complementary security elements of the sheet.

7. A sheet according to claim 1, the zone of reduced opacity presenting an opacity index that is less than or equal to 80% in accordance with the ISO 2469 standard.

8. A sheet according to claim 1, the zone of reduced opacity being made from a non-filled highly refined fiber composition.

9. A sheet according to claim 1, the zone of reduced opacity being made from a tracing paper.

10. A sheet according to claim 1, the zone of reduced opacity being made from a composition of synthetic fibers.

11. A sheet according to claim 1, the zone of reduced opacity being made from a polymer material.

12. A sheet according to claim 1, the zone of reduced opacity being made from a composition of polyolefin fibers, the fibers being subjected to localized melting by heat treatment.

13. A sheet according to claim 1, the zone of reduced opacity being made from a material that has previously been subjected to wet strength (WS) treatment.

14. A sheet according to claim 1, the ribbon being made from a crease-resistant fiber sheet that is transparent or translucent with an opacity index of less than 50%, comprising fibers, an anionic polymer presenting a glass transition temperature higher than 45° C. and at a concentration lying in the range 5% to 40% by dry weight relative to the total dry weight of the sheet used for making the ribbon, and a main cationic flocculation agent at a concentration lying in the range 0.1% to 10% by dry weight relative to the total dry weight of the sheet used for making the ribbon.

15. A sheet according to claim 1, the two security elements serving to obtain moiré effects in show-through.

16. A sheet according to claim 1, the two security elements being printing.

17. A sheet according to claim 1, the two security elements appearing on a foil and/or a patch applied to the recto and/or the verso of the substrate at least in register with the zone of reduced opacity.

18. A sheet according to claim 1, the ribbon including in register with the zone of reduced opacity one or more patterns made with one or more transparentizing inks, said pattern(s) defining one or more show-through observation windows of the sheet.

19. A security document including a sheet as defined in claim 1.

20. An article to be authenticated including a sheet as defined in claim 1.

21. An article according to claim 20, the article being selected from a security label, packaging, a sheet used in the medical or hospital field, or art paper.
